(19) United States
(12) Patent Application Publication
(10) Pub. No.: US 2017/0198711 A1
(43) Pub. Date: Jul. 13, 2017

(54) PNEUMATIC TOOL AND ROTATION MECHANISM THEREOF

(71) Applicant: HYPHONE MACHINE INDUSTRY CO., LTD., Taichung City (TW)

(72) Inventors: Chih-Ming TING, Taichung City (TW); Tien LIN, Taichung City (TW); Po-Jen LAI, Taichung City (TW)

(21) Appl. No.: 14/991,243

(22) Filed: Jan. 8, 2016

(51) Int. Cl. F04D 29/28; F04D 29/42; B25F 5/00

(52) U.S. Cl. CPC F04D 29/281; B25F 5/00; F04D 29/4206

(57) ABSTRACT

A rotation mechanism includes a first shell portion and a rotor. A first shell portion has at least one inlet and outlet annular faces, the inlet and outlet annular faces surround a same axis, and the inlet and outlet annular faces are axially alternatively arranged. The rotor is rotatably disposed within the first shell portion and includes annular blade areas each having blades, and each annular blade area partially corresponds to inlet and outlet annular faces respectively. The pneumatic tool includes the rotation mechanism, a second shell portion receiving the rotation mechanism and a rotation axle. The second shell portion has at least one outlet channel communicating with the outlet through hole of the outlet annular face and at least one inlet channel communicating with the inlet through hole of the inner annular face. The rotation axle is assembled to the rotation mechanism.

### BACKGROUND OF THE INVENTION

Field of the Invention

The present invention relates to a pneumatic tool and a rotation mechanism thereof.

Description of the Prior Art

Conventionally, a rotation mechanism of a common pneumatic tool has a shell body and a rotor disposed in the shell body. The shell body has an inlet opening and an outlet opening, the inlet opening and the outlet opening correspond to the rotor laterally and radially, a high-pressure air enters from the inlet opening and toward a lateral face of the rotor, and the high-pressure air flows through a flow passage between blades and flows in a radial direction of the rotor to the outlet opening so as to produce an force to make the rotor rotate. The pneumatic tool may be used to grind or screw an object. This type of pneumatic tool and the rotation mechanism thereof are disclosed in TWM507326.

However, the outlet and inlet openings of this type of conventional pneumatic tool are located on the rotor and face toward different directions; therefore, when the air enters, the force that air provides is separated, and an efficiency of using the force is poor. In addition, there is only one inlet opening, so the rotor is unable to provide enough energy.

The present invention is, therefore, arisen to obviate or at least mitigate the above-mentioned disadvantages.

### SUMMARY OF THE INVENTION

The main object of the present invention is to provide a pneumatic tool and a rotation mechanism thereof, wherein both of an inlet through hole of an inner annular face and an outlet through hole of an outer annular face correspond to a radial direction of a rotor, an inlet force of air can be transmitted to blades efficiently; and the rotation mechanism at least has two said inlet annular faces to provide efficient inlet air and elevate dynamic force.

To achieve the above and other objects, a rotation mechanism is provided for being assembled in a pneumatic tool, and the rotation mechanism includes a first shell portion and a rotor. The first shell portion defines an annular receiving space, an inner wall of the annular receiving space has at least one inlet annular face and at least one outlet annular face, each said inlet annular face is radially formed with at least one inlet through hole communicating with the annular receiving space, each said outlet annular face is radially formed with at least one outlet through hole communicating with the annular receiving space, each said inlet annular face and each said outlet annular face surround a same axis, and each said inlet annular face and each said annular face are axially alternatively arranged. The rotor is rotatably disposed within the annular receiving space, an outer peripheral face of the rotor includes a plurality of annular blade areas, each said annular blade area is provided with a plurality of blades, and each said annular blade area partially corresponds to one said inlet annular face and partially corresponds to one said outlet annular face.

To achieve the above and other objects, the pneumatic tool is further provided. The pneumatic tool includes the rotation mechanism mentioned above and further includes a second shell portion and a rotation axle. The second shell portion has a chamber which receives the rotation mechanism, and the second shell portion is formed with at least one outlet channel communicating with outside and the at least one outlet through hole and at least one inlet channel communicating with the outside and the at least one inlet through hole. The rotation axle is disposed in the rotation mechanism and for being assembled to a work piece, and the rotation axle and the rotation mechanism are rotatably connected with each other synchronously.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a preferred embodiment of the present invention in use;

FIG. 2 is a perspective view of the preferred embodiment of the present invention;

FIG. 3 is a breakdown view of the preferred embodiment of the present invention;

FIG. 4 is a perspective view of a rotation mechanism of the preferred embodiment of the present invention;

FIG. 5 is a cross-sectional view of the present invention, taken along line A-A in FIG. 2;

FIG. 6 is a cross-sectional view of the present invention, taken along line B-B in FIG. 2;

FIG. 7 is a cross-sectional view of the present invention, taken along line C-C in FIG. 2; and

FIG. 8 is a perspective view of a part of a second shell portion of the present invention.

### DETAILED DESCRIPTION OF THE PREFERRED EMBODIMENTS

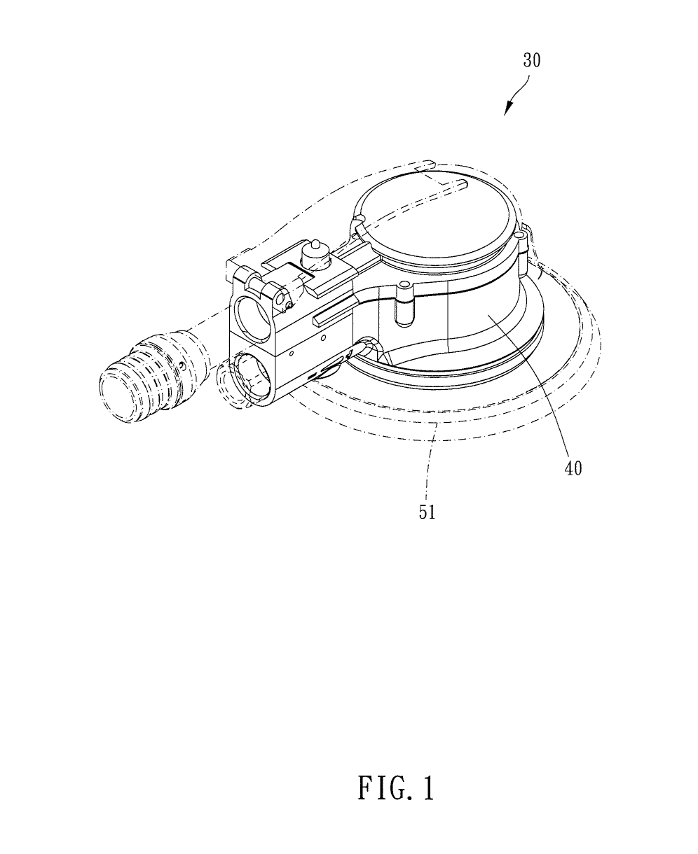

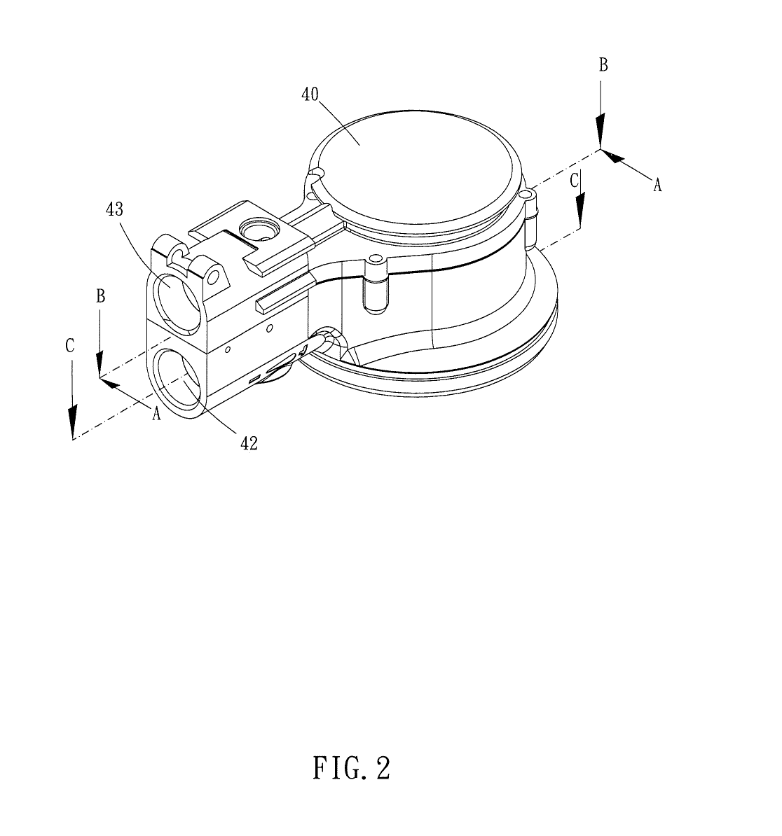

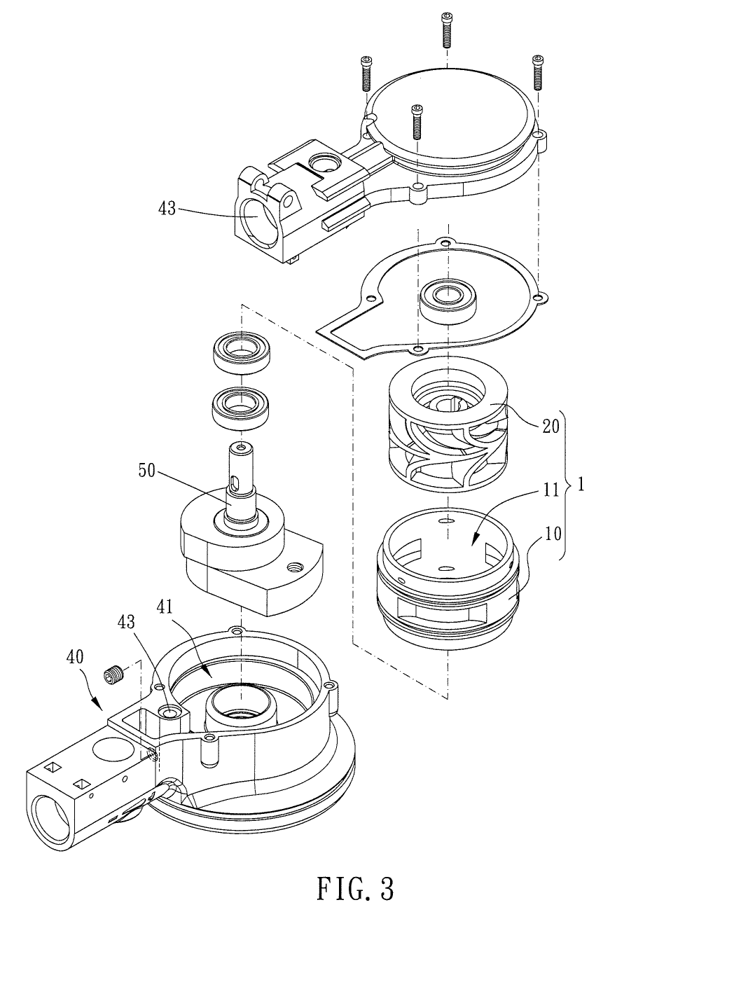

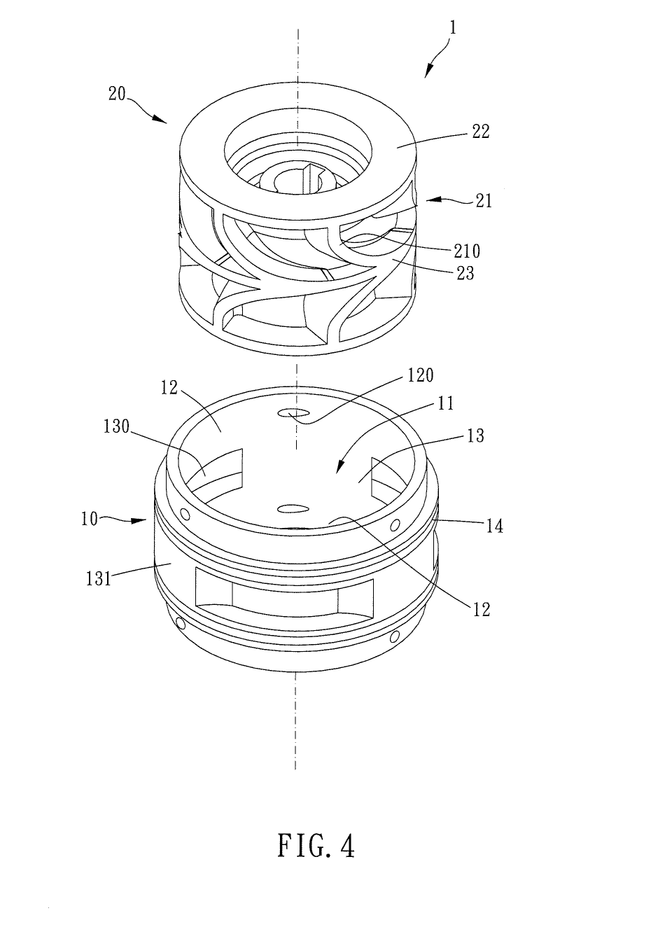

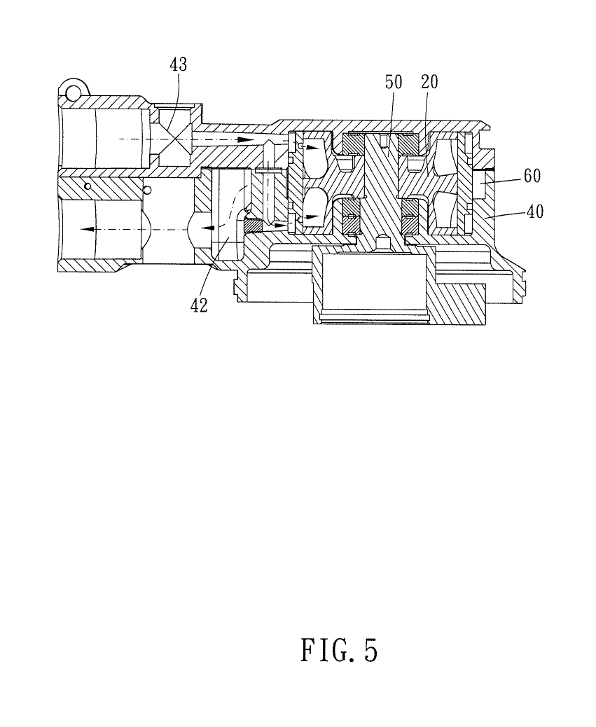

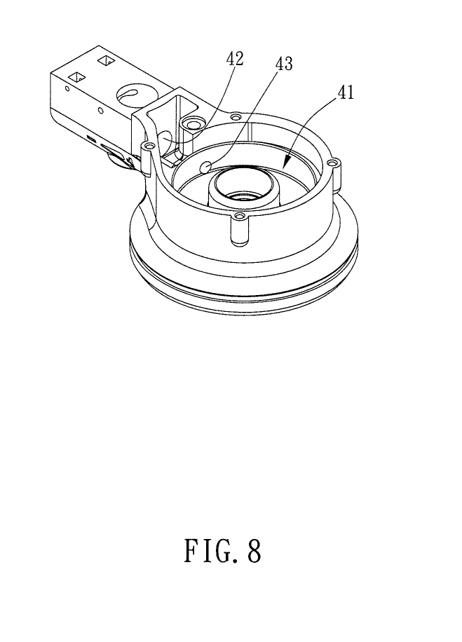

Please refer to FIGS. 1 to 8 for a preferred embodiment of the present invention. A rotation mechanism 1 is provided for being assembled in a pneumatic tool 30, and the rotation mechanism 1 includes a first shell portion 10 and a rotor 20.

The first shell portion 10 defines an annular receiving space 11, an inner wall of the annular receiving space 11 has at least one inlet annular face 12 and at least one outlet annular face 13, each said inlet annular face 12 is radially formed with at least one inlet through hole 120 communicating with the annular receiving space 11, and each said outlet annular face 13 is radially formed with at least one outlet through hole 130 communicating with the annular receiving space 11. Preferably, the inner wall of the annular receiving space 11 has a plurality of said inlet annular faces 12, and a number of the inlet annular faces 12 is greater than a number of the at least one outlet annular face 13; therefore, the rotor 20 can be provided with greater air inlet amount to elevate an output force of the rotor 20. Specifically, each said inlet annular face 12 and each said outlet annular face 13 surround a same axis, and each said inlet annular face 12 and each said outlet annular face 13 are axially alternatively arranged. In addition, each said inlet annular face 12 is formed with a plurality of said inlet through holes 120, and each said outlet annular face 13 is formed with a plurality of said outlet through holes 130; and in other embodiments, the outlet annular face or/and the inlet annular face may be formed with a longitudinal through hole letting air in or/and out.

In this embodiment, the annular receiving space 11 has two said inlet annular faces 12 and one said outlet annular face 13, and every two of said inlet annular faces 12 are arranged spacingly with the outlet annular face 13 arranged therebetween. Two of the plurality of said inlet annular faces 12 are arranged neighboringly on two opposite sides of the annular receiving space 11 so that two sides of the rotor can obtain an inlet air force evenly and stably. In other embodiment, there may be more outlet annular faces and inlet annular faces, or different inlet annular faces may be arranged neighboringly to each other so as to elevate a rotation force of the rotor.

The rotor 20 is rotatably disposed within the annular receiving space 11, and an outer peripheral face of the rotor 20 includes a plurality of annular blade areas 21, each said annular blade area 21 is formed with a plurality of blades 210, and each said annular blade area 21 partially corresponds to one said inlet annular face 12 and partially corresponds to one said outlet annular face 13; therefore, air which enters from the inlet through hole 120 of each said inlet annular face 12 can be discharged quickly from the outlet through hole 130 of each said outlet annular face 13 to prevent backpressure.

Specifically, each said outlet annular face 13 is formed with a plurality of barriers 131, the barriers 131 define the plurality of said outlet through holes 130, and each inlet through hole 120 of each said inlet annular face 12 is arranged correspondingly to one said barrier 131. More specifically, when one said blade 120 of one of said annular blade areas 21 rotates to correspond to one said inlet through hole 120, another blade 210 neighboring to the one said blade 210 corresponds to one said outlet through hole 130, so a number of the blades 210 of each said annular blade area 21 is twice a number of the barriers 131 of one of the at least one outlet annular face 13. Therefore, the air can be prevented from flowing from each said inlet through hole 120 and out from each said outlet through hole 130 (blocked by the barrier 131), the air pushes each said blade for a distance (a gap between two neighboring blades 210) first and flows through each said outlet through hole 130 so that each said blade 210 functions more efficiently.

To prevent the air from flowing out from the two sides of the rotor 20, the two opposite sides of the rotor 20 are protrudingly formed with an annular blocking wall 22, and the annular blade areas 21 are disposed between the two annular blocking walls 22.

The rotor 20 is provided with an annular protrusion 23 which corresponds to the outlet annular face 13 between two neighboring said annular blade areas 21, and the annular protrusion 23 is connected with the blades 210 of two neighboring said annular blade areas 21. It is understandable that the annular protrusion 23 can guide the air between two neighboring said blades 210 to each said outlet through hole 130. In this embodiment, the rotor 20 includes two said annular blade areas 21 and one said annular protrusion 23, each said blade 210 of one of said annular blade areas 21 and each said blade 210 of the other of said annular blade areas 21 are arranged correspondingly to each other, and two said blades 210 of the two annular blade areas 21 correspondingly arranged and a part of the annular protrusion 23 form a substantially inverted Y-shaped structure. Preferably, each said inlet through hole 120 is radially and obliquely formed relative to the inlet annular face 12 (as shown in FIG. 7), and a part of each said blade 210 (flat parts on two sides of the inverted Y-shaped structure) corresponds to each said inlet through hole 120 and obliquely extends from the outer peripheral face of the rotor 20 toward the outside; therefore, the air entering from each said inlet through hole 120 can transmit force to each blade 210 more efficiently.

A pneumatic tool 30 is further provided. The pneumatic tool 30 includes the rotation mechanism 1 mentioned above, and further includes a second shell portion 40 and a rotation axle 50.

The second shell portion 40 has a chamber 41 which receives the rotation mechanism 1, and the second shell portion 40 is formed with at least one outlet channel 42 communicating with the outside and the at least one outlet through hole 130 and at least one inlet channel 43 communicating with the outside and the at last one inlet through hole 120. In this embodiment, the second shell portion 40 is formed with two said inlet channels 43 respectively communicating with one said inlet through hole 120 and one said outlet channel 42 communicating with the outlet through hole 130. In addition, the rotation axle 50 is disposed in the rotation mechanism 1 and for being assembled to a work piece 51, and the rotation axle 50 and the rotation mechanism 1 are rotatably connected with each other and rotate synchronously.

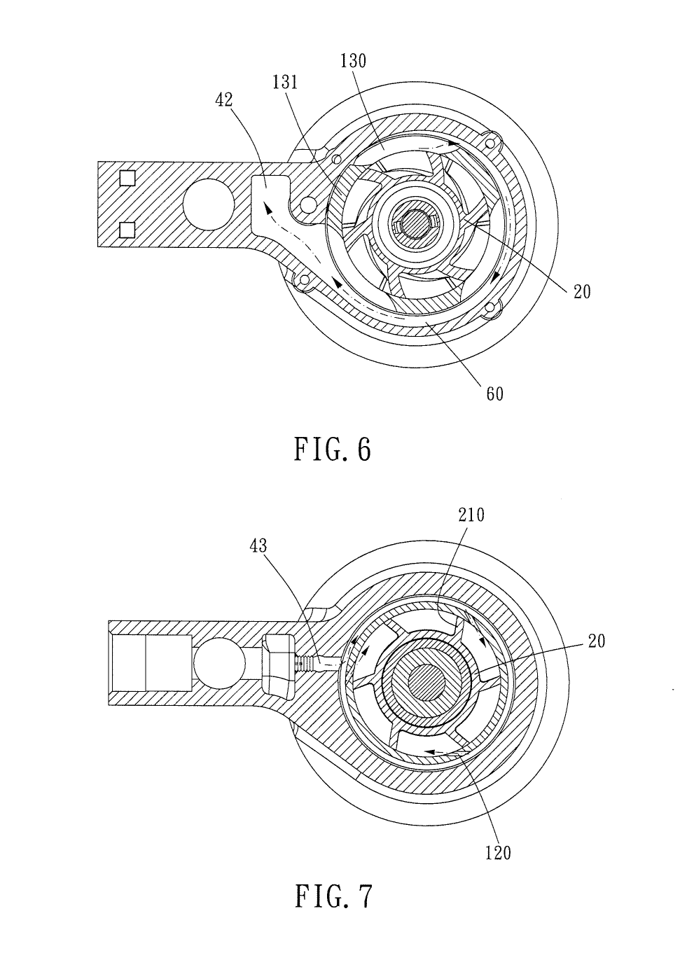

In this embodiment, the chamber 41 is an annular chamber, the first shell portion 10 is an annular shell portion, the inner wall of the chamber 41 corresponding to each said outlet annular face 13 and the first shell portion 10 define a flow passage 60 which is substantially hook-shaped therebetween (as shown in FIG. 6), the flow passage 60 communicates with each said outlet through hole 130 and the outlet channel 42, and the flow passage 60 expands gradually from one said outlet through hole 130 toward one said outlet channel 42 so that the air can be quickly discharged from the flow passage 60 to prevent backpressure.

Furthermore, an annular protrusive wall 14 is formed between the outer peripheral face of the first shell portion 10 and the inner wall of the chamber 41, each said annular protrusive wall 14 corresponds to a portion between one said inlet annular face 12 and one said outlet annular face 13, and each said annular protrusive wall 14 abuts against the first shell portion 10 and the chamber 41. More specifically, each said annular protrusive wall 14 extends from the first shell portion 10 to separate the air flowing into each said inlet through hole 120 and the air discharged from each said outlet through hole 130 to prevent the air flowing in and out from interfering with each other.

Given the above, the inlet through hole of the inlet annular face and the outlet through hole of the outlet annular face correspond to a radial direction of the rotor, and the inlet air force can be transmitted to the blade efficiently.

In addition, the rotation mechanism at least has two inlet annular faces and can provide sufficient amount of inlet air to elevate dynamic force.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A rotation mechanism, provided for being assembled in a pneumatic tool, including:
a first shell portion, defining an annular receiving space, an inner wall of the annular receiving space having at least one inlet annular face and at least one outlet annular face, each said inlet annular face radially formed with at least one inlet through hole communicating with the annular receiving space, each said outlet annular face radially formed with at least one outlet through hole communicating with the annular receiving space, each said inlet annular face and each said outlet annular face surrounding a same axis, each said inlet annular face and each said outlet annular face being axially alternatively arranged;
a rotor, rotatably disposed within the annular receiving space, an outer peripheral face of the rotor including a plurality of annular blade areas, each said annular blade area formed with a plurality of blades, each said annular blade area partially corresponding to one said inlet annular face and partially corresponding to one said outlet annular face.

2. The rotation mechanism of claim 1, wherein the inner wall of the annular receiving space has a plurality of said inlet annular faces, and a number of the inlet annular faces is greater than a number of the at least one outlet annular face.

3. The rotation mechanism of claim 2, wherein every two of said inlet annular faces are arranged spacingly with one said outlet annular face being arranged therebetween.

4. The rotation mechanism of claim 3, wherein each said outlet annular face is formed with a plurality of barriers, and the barriers define a plurality of said outlet through holes.

5. The rotation mechanism of claim 4, wherein a number of the blades of each said annular blade area is twice a number of the barriers of one of the at least one outlet annular face.

6. The rotation mechanism of claim 5, wherein two of the plurality of inlet annular faces are arranged neighboringly to two opposite sides of the annular receiving space, each said inlet through hole is radially and obliquely formed relative to the inlet annular face, and a part of each said blade corresponds to each said inlet through hole and obliquely extends from the outer peripheral face of the rotor toward outside.

7. The rotation mechanism of claim 5, wherein two opposite sides of the rotor are respectively formed with an annular blocking wall, the annular blade areas are disposed between the two annular blocking walls, the rotor is formed with an annular protrusion between two neighboring said annular blade areas and corresponding to the outlet annular face, and the annular protrusion is connected with the blades of two neighboring said annular blade areas.

8. The rotation mechanism of claim 7, wherein the rotor includes two said annular blade areas and one said annular protrusion, each said blade of one of said annular blade areas and each said blade of the other of said annular blade areas are arranged correspondingly to each other, and two said blades of the two annular blade areas correspondingly arranged and a part of the annular protrusion form a substantially inverted Y-shaped structure.

9. A pneumatic tool, including the rotation mechanism of claim 1, further including:
a second shell portion, having a chamber for receiving the rotation mechanism, and the second shell portion formed with at least one outlet channel communicating with outside and the at least one outlet through hole and at least one inlet channel communicating with the outside and the at least one inlet through hole;
a rotation axle, disposed in the rotation mechanism for being assembled to a work piece, the rotation axle and the rotation mechanism rotatably connected with each other synchronously.

10. The pneumatic tool of claim 9, wherein the chamber is an annular chamber, the first shell portion is an annular shell portion, the inner wall of the chamber corresponding to each said outlet annular face and the first shell portion define a flow passage which is substantially hook-shaped therebetween, the flow passage communicates with each said outlet through hole and the outlet channel, the flow passage expands gradually from one said outlet through hole toward one said outlet channel, an annular protrusive wall is formed between the outer peripheral face of the first shell portion and the inner wall of the chamber, each said annular protrusive wall corresponds to a portion between one said inlet annular face and one said outlet annular face, and each said annular protrusive wall abuts against the first shell portion and the chamber.
